(19) United States
(12) Patent Application Publication
(10) Pub. No.: US 2018/0182515 A1
(43) Pub. Date: Jun. 28, 2018

(54) RARE EARTH MAGNET AND PRODUCTION METHOD THEREOF

(71) Applicant: TOYOTA JIDOSHA KABUSHIKI KAISHA, Toyota-shi (JP)

(72) Inventors: Masaaki ITO, Susono-shi (JP); Noritsugu SAKUMA, Mishima-shi (JP); Masao YANO, Suntou-gun (JP); Hidefumi KISHIMOTO, Susono-shi (JP); Tetsuya SHOJI, Susono-shi (JP)

(73) Assignee: TOYOTA JIDOSHA KABUSHIKI KAISHA, Toyota-shi (JP)

(21) Appl. No.: 15/846,317

(22) Filed: Dec. 19, 2017

(30) Foreign Application Priority Data
Dec. 28, 2016 (JP) 2016-256855

(51) Int. Cl. H01F 1/058; H01F 41/02; C22C 38/16; C22C 38/06; C22C 38/00; B22F 3/24

(52) U.S. Cl. CPC H01F 1/058; H01F 41/0253; C22C 38/16; C22C 38/06; B22F 2301/355; C22C 38/002; B22F 3/24; C22C 2202/02; B22F 2003/248; C22C 38/005

(57) ABSTRACT

A rare earth magnet comprising a main phase, a grain boundary phase present around the main phase, and an intermediate phase sandwiched between the main phase and the grain boundary phase, and having a total composition of the rare earth magnet represented by the formula: CeₚR¹_{q}T_{(100-p-q-r-s)}BᵣM¹ₛ.(R²₁₋ₓM²ₓ)ₜ R¹ and R² are a rare earth element except for Ce, T is one or more members selected from Fe, Ni, and Co, M¹ is a minor element, and M² is an alloy element that makes, the melting point of R²₁₋ₓM²ₓ to be lower than the melting point of R² the concentration of Ce is higher in the main phase than in the intermediate phase, and the concentration of R² is higher in the intermediate phase than in the main phase, and a production method thereof.

### TECHNICAL FIELD

The present disclosure relates to an R—Fe—B-based rare earth magnet (R is a rare earth element) and a production method thereof. More specifically, the present disclosure relates to an R—Fe—B-based rare earth magnet in which R is mainly Ce and a production method thereof.

### BACKGROUND ART

An R—Fe—B-based rear earth magnet is a high-performance magnet having excellent magnetic properties and is therefore used for a motor constituting a hard disk, MRI (magnetic resonance imaging) device, etc. and in addition, used for a driving motor of a hybrid vehicle, an electric vehicle, etc.

A rare earth magnet where R is Nd, i.e., an Nd—Fe—B-based rare earth magnet, is the most representative of the R—Fe—B-based rare earth magnet. However, the price of Nd is increasing, and it is being attempted to replace a part of Nd in the Nd—Fe—B-based rare earth magnet by Ce, La, Gd, Y and/or Sc, which are less expensive than Nd.

Patent Document 1 discloses an (Nd,Ce)—Fe—B-based rare earth magnet where Ce substitutes for a part of Nd of an Nd—Fe—B-based rare earth magnet.

### RELATED ART

### Patent Document

[Patent Document 1] Japanese unexamined patent publication) No. 2016-111136 (JP 2016-111136 A)

### SUMMARY OF THE INVENTION

### Problems to be Solved by the Invention

The (Nd,Ce)—Fe—B-based rare earth magnet disclosed in Patent Document 1 comprises from 1.25 to 20.00 at % of Nd, and studies are not sufficiently made on enhancement of the magnetic properties, particularly the coercive force, when Nd is very small in content or is not present.

Under these circumstances, the present inventors have found that the R—Fe—B-based rare earth magnet where R is mainly Ce has room for improvement of the coercive force when a rare earth element R¹ except for Ce is very small in amount or is not present.

The present disclosure has been made to solve the task above. An object of the present disclosure is to provide an R—Fe—B-based rare earth magnet where R is mainly Ce, ensuring that even when a rare earth element R¹ except for Ce is very small in amount or is not present, the coercive force can be enhanced, and a production method thereof.

### Means to Solve the Problems

The present inventors have made many intensive studies to attain the object above and accomplished the rare earth magnet of the present disclosure. The gist thereof is as follows.

<1> A rare earth magnet comprising:

a main phase,

a grain boundary phase present around the main phase, and

an intermediate phase sandwiched between the main phase and the grain boundary phase, and

wherein a total composition of the rare earth magnet is represented by the formula: CeₚR¹_{q}T_{(100-p-q-r-s)}BᵣM¹ₛ.(R²₁₋ₓM²ₓ)ₜ (wherein R¹ and R² are a rare earth element except for Ce, T is one or more elements selected from Fe, Ni, and Co, M¹ is one or more elements selected from Ti, Ga, Zn, Si, Al, Nb, Zr, Mn, V, W, Ta, Ge, Cu, Cr, Hf, Mo, P, C, Mg, Hg, Ag, and Au, and an unavoidable impurity, M² is an alloy element that makes, by alloying with R², the melting point of R²₁,M²ₓ to be lower than the melting point of R², and an unavoidable impurity, and

p, q, r, s, t, and x are

11.80≤p≤12.90,

0≤q≤3.00,

5.00≤r≤20.00,

0≤s≤3.00,

1.00≤t≤11.00, and

0.10≤x≤0.50),

the concentration of Ce is higher in the main phase than in the intermediate phase, and

the concentration of R² is higher in the intermediate phase than in the main phase.

<2> The rare earth magnet according to item <1>, wherein the p is 11.80≤p≤12.20.

<3> The rare earth magnet according to item <1> or <2>, wherein the q is 0≤q≤2.00.

<4> The rare earth magnet according to item <1> or <2>, wherein the q is 0≤q≤1.00.

<5> The rare earth magnet according to any one of items <1> to <4>, wherein the volume fraction of the main phase is from 85.00 to 96.20%.

<6> The rare earth magnet according to any one of items <1> to <5>, wherein the R¹ is one or more elements selected from Nd, Pr, Dy, and Tb.

<7> The rare earth magnet according to any one of items <1> to <6>, wherein the R² is one or more elements selected from Nd, Pr, Dy, and Tb.

<8> The rare earth magnet according to any one of items <1> to <7>, wherein the concentration of Ce is from 1.5 to 10.0 times higher in the main phase than in the intermediate phase.

<9> The rare earth magnet according to any one of items <1> to <8>, wherein the concentration of R² is from 1.5 to 10.0 times higher in the intermediate phase than in the main phase.

<10> The rare earth magnet according to any one of items <1> to <9>, wherein the x is 0.20≤x≤0.40.

<11> The rare earth magnet according to any one of items <1> to <10>, wherein the thickness of the intermediate phase is from 5 to 50 nm.

<12> The rare earth magnet according to any one of items <1> to <11>, wherein the T is Fe.

<13> A method for producing a rare earth magnet, comprising:

preparing a rare earth magnet precursor comprising
a total composition of the rare earth magnet represented by the formula: CeₚR¹_{q}T_{(100-p-q-r-s)}BᵣM¹ₛ (wherein R¹ is a rare earth element except for Ce, T is one or more elements selected from Fe, Ni, and Co, M¹ is one or more elements selected from Ti, Ga, Zn, Si, Al, Nb, Zr, Mn, V, W, Ta, Ge, Cu, Cr, Hf, Mo, P, C, Mg, Hg, Ag, and Au, and an unavoidable impurity, and

p, q, r, and s are

11.80≤p≤12.90,

0≤q≤3.00,

5.00≤r≤20.00, and

0≤s≤3.00), and
a magnetic phase and a (Ce,R¹)-rich phase present around the magnetic phase,

preparing a modifier comprising an alloy represented by R²₁₋ₓM²ₓ (wherein R² is a rare earth element except for Ce, M² is an alloy element that makes, by alloying with R², the melting point of R²₁₋ₓM²ₓ to be lower than the melting point of R², and an unavoidable impurity, and 0.10≤x≤0.50),

bringing the rare earth magnet precursor and the modifier into contact with each other to obtain a contact body, and

heat-treating the contact body to infiltrate the inside of the magnetic phase of the rare earth magnet precursor with a melt of the modifier.

<14> The method according to item <13>, wherein the p is 11.80≤p≤12.20.

<15> The method according to item <13> or <14>, wherein the q is 0≤q≤2.00.

<16> The method according to item <13> or <14>, wherein the q is 0≤q≤1.00.

<17> The method according to any one of items <13> to <16>, wherein R¹ is one or more elements selected from Nd, Pr, Dy, and Tb.

<18> The method according to any one of items <13> to <17>, wherein R² is one or more elements selected from Nd, Pr, Dy, and Tb and M² is one or more elements selected from Cu, Al, and Co, and an unavoidable impurity.

<19> The method according to any one of items <13> to <18>, wherein the x is 0.20≤x≤0.40.

<20> The method according to any one of items <13> to <19>, wherein the amount of the modifier infiltrated is from 1.0 to 11.0 at % relative to the rare earth magnet precursor.

<21> The method according to any one of items <13> to <20>, wherein the temperature of the heat treatment is from 600 to 800° C.

<22> The method according to any one of items <13> to <21>, wherein the T is Fe.

### Effects of the Invention

According to the present disclosure, the Ce content is specified in a predetermined range, and a rare earth magnet and a production method thereof, ensuring that the coercive force can be enhanced even when a rare earth element R¹ except for Ce is very small in content or is not present, can thereby be provided.

### BRIEF DESCRIPTION OF THE DRAWINGS

FIG. 1 is a diagram schematically illustrating the structure of the rare earth magnet of the present disclosure.

FIG. 2 is a diagram schematically illustrating the structure of the rare earth magnet precursor.

FIG. 3 is a graph illustrating the relationship between the Ce content and the coercive force before infiltration with a modifier in each sample.

FIG. 4 is a graph illustrating the relationship between the volume fraction of the magnetic phase and the magnetization before infiltration with a modifier in each sample.

FIG. 5 is a graph illustrating the relationship between the Ce content and the coercive force after infiltration with a modifier in each sample.

FIG. 6 is a graph illustrating the relationship between the volume fraction of the main phase and the magnetization after infiltration with a modifier in each sample.

FIG. 7 is a view showing a scanning transmission electron microscope (STEM) image of the sample of Example 1.

FIG. 8 is a diagram illustrating the results of component analysis (EDX analysis) of a portion surrounded by a black line in FIG. 7.

FIG. 9 is a diagram summarizing the results of FIG. 8.

### MODE FOR CARRYING OUT THE INVENTION

The embodiments of the rare earth magnet and the production method thereof according to the present disclosure are described in detail below. The embodiments described below should not be construed to limit the rare earth magnet and the production method thereof according to the present disclosure.

In the present description, with respect to an R—Fe—B-based rare earth magnet where R is mainly Ce, a rare earth magnet where a rare earth element R¹ except for Ce is very small in content or it not present is sometimes referred to as a (Ce,R¹)—Fe—B-based rare earth magnet.

The (Ce,R¹)—Fe—B-based rare earth magnet is obtained by liquid quenching, etc. of a molten (Ce,R¹)—Fe—B-based alloy. A magnetic phase represented by (Ce,R¹)₂Fe₁₄B (hereinafter, such a phase is sometimes referred to as “(Ce,R¹)₂Fe₁₄B phase”) is formed by the liquid quenching, etc. In the residual liquid after the (Ce,R¹)₂Fe₁₄B phase is formed, a (Ce,R¹)-rich phase is formed by excess Ce and R¹ each not contributing to the formation of the (Ce,R¹)₂Fe₁₄B phase. The (Ce,R¹)-rich phase is present around the (Ce,R¹)₂Fe₁₄B phase. The (Ce,R¹)-rich phase is formed by elements not contributing to the formation of the (Ce,R¹)₂Fe₁₄B phase and contains high concentrations of Ce and R¹.

In the (Ce,R¹)—Fe—B-based rare earth magnet, if the entirety is a (Ce,R¹)₂Fe₁₄B phase, the total content of Ce and R¹ is roughly 11.8 at %. Because, assuming that the total content of Ce, R¹, Fe and B is 100 at %, the total content of Ce and R¹ is roughly 11.8 (=100/(2+14+1)*2) at %.

If the total content (at %) of Ce and R¹ is small, the proportion of the (Ce,R¹)-rich phase decreases. The (Ce,R¹)-rich phase magnetically separates (Ce,R¹)₂Fe₁₄B phases from each other and contributes to enhancement of the coercive force of the (Ce,R¹)—Fe—B-based rare earth magnet.

Usually, when the rare earth-rich phase is decreased, the coercive force of the rare earth magnet decreases. However, the present inventors have found that in the case of a (Ce,R¹)—Fe—B-based rare earth magnet, even when the (Ce,R¹)-rich phase is decreased, i.e., the total content (at %) of Ce and R¹ is small, the coercive force does not decrease.

In addition, at the time of infiltrating the (Ce,R¹)—Fe—B-based rare earth magnet with a modifier, when an alloy in the modifier mainly contains Ce, a rare earth element in the modifier can hardly infiltrate into the (Ce,R¹)₂Fe₁₄B phase. For example, at the time of infiltrating the (Ce,Nd)—Fe—B-based rare earth magnet with a modifier comprising a Ce—Cu alloy, Ce in the modifier is easily to stay in the (Ce,Nd)-rich phase and can hardly infiltrate into the (Ce,Nd)₂Fe₁₄B phase.

On the other hand, when an alloy in the modifier mainly comprises a rare earth element different from Ce, the rare earth element in the modifier is easy to infiltrate into the (Ce,R¹)Fe₁₄B phase. For example, at the time of infiltrating the (Ce,R¹)—Fe—B-based rare earth magnet with a modifier comprising an Nd—Cu alloy, Nd in the modifier is easy to infiltrate into the (Ce,R¹)₂Fe₁₄B phase.

In the case of a (Ce,R¹)—Fe—B-based rare earth magnet, the content of R¹ is very small relative to Ce. The present inventors have found that for this reason, not only when the modifier comprises mainly a rare earth element except for Ce and R¹ but also even when the modifier mainly contains R¹, the rare earth element of an alloy in the modifier is easy to infiltrate into the (Ce,R¹)₂Fe₁₄B phase.

The configuration of the rare earth magnet according to the present disclosure based on the finding above is described below.

### (Total Composition)

The total composition of the rare earth magnet of the present disclosure is represented by the formula: CeₚR¹_{q}T_{(100-p-q-r-s)}BᵣM¹ₛ.(R²₁₋ₓM²ₓ)ₜ.

In the formula, R¹ and R² are a rare earth element except for Ce. T is one or more elements selected from Fe, Ni, and Co. M¹ is one or more elements selected from Ti, Ga, Zn, Si, Al, Nb, Zr, Mn, V, W, Ta, Ge, Cu, Cr, Hf, Mo, P, C, Mg, Hg, Ag, and Au, and an unavoidable impurity. M² is an alloy element that makes, by alloying with R², the melting point of R²₁₋ₓM²ₓ to be lower than the melting point of R², and an unavoidable impurity.

p is the content of Ce, q is the content of R¹, r is the content of B (boron), s is the content of M¹, t is the total content of R² and M², and each of the values p, q, r, s, and t is at %.

The rare earth magnet of the present disclosure is obtained, as described later, by infiltrating a rare earth magnet precursor with a modifier. The rare earth magnet precursor comprises a total composition represented by CeₚR¹_{q}T_{(100-p-q-r-s)}BᵣM¹ₛ. The modifier comprises an alloy having a composition represented by R²_{1-z}M²_{z}.

The amount of an alloy infiltrated into the rare earth magnet precursor is t at %, i.e., from 1.0 to 11.0 at %. Accordingly, the total composition of the rare earth magnet of the present disclosure becomes a total of a composition represented by CeₚR¹_{q}T_{(100-p-q-r-s)}BᵣM¹ₛ and a composition represented by (R²_{1-z}M²z)ₜ. The composition formulated by combining these is represented by the formula: CeₚR¹_{q}T_{(100-p-q-r-s)}BᵣM¹ₛ.(R²₁₋ₓM²ₓ)ₜ . Respective contents of Ce, R¹, T, B, M¹ and M² are described below.

### (Ce)

When the content p of Ce is 12.90 at % or less, the coercive force can be enhanced. From the viewpoint of enhancing the coercive force, the content p of Ce is preferably 12.87 at % or less, more preferably 12.20 at % or less, still more preferably 12.15 at % or less. On the other hand, when the Ce content p is 11.80 at % or more, enhancement of the coercive force is not saturated. The content is preferably 11.85 at % or more.

Not wishing to be bound by theory, R¹ in the R¹-rich phase is considered to be often present by itself without bonding to Fe, etc. On the other hand, it is considered that Ce in the Ce-rich phase is present in the state of being bonded to Fe, etc. and as a result, compared with the R¹-rich phase, the Ce-rich phase exhibits an excellent effect of magnetically separating magnetic phases from each other even when the amount thereof is small. For this reason, the content of R¹ in the (Ce,R¹)-rich phase is preferably as small as possible.

### (R¹)

When the content q of R¹ is small, the content of R¹ in the (Ce,R¹)-rich phase is small as well. When the content q of R¹ in the total composition is 3.00 at % or less, the coercive force does not lower. From this point of view, the content q of R¹ is preferably 2.00 at % or less, more preferably 1.00 at % or less, and is ideally 0 at %. On the other hand, for the reason that if the content q of R¹ is excessively decreased, the production cost increases, the content q of R¹ is preferably 0.10 at % or more.

R¹ may be one or more elements selected from Nd, Pr, Dy and Tb, and the content of Nd may be 90.00 at % or more relative to the entire R¹.

### (B)

When the content r of B is 5.00 at % or more, the amount of an amorphous structure remaining inside a ribbon, etc. at the time of liquid quenching does not become 10.00 vol % or more relative to the entire rare earth magnet. On the other hand, when the content r of B is 20.00 at % or less, B forming no solid solution with Fe does not remain excessively in the (Ce,R¹)-rich phase. From this point of view, the content r of B is preferably 10.00 at % or less, more preferably 8.00 at % or less.

### (M¹)

M¹ may be comprised within a range not impairing the properties of the rare earth magnet of the present disclosure. M¹ may comprise an unavoidable impurity. The unavoidable impurity indicates an impurity that is unavoidably contained or causes a significant rise in the production cost for avoiding its inclusion, such as impurity contained in a raw material. When the content s of M¹ is 3.00 at % or less, the properties of the rare earth magnet of the present disclosure are not degraded. The content s of M¹ is preferably 2.00 at % or less and is ideally 0. However, excessively decreasing the content s of M¹ is accompanied by a rise in the production cost and therefore, the content s of M¹ is preferably 0.10 at % or more.

### (T)

T is classified into an iron group element, and Fe, Ni and Co have a common property of exhibiting ferromagnetism at normal temperature and normal pressure. Accordingly, these may be interchanged with each other. When Co is comprised, the magnetization is improved, and the Curie point increases. This effect is exhibited at a Co content of 0.10 at % or more. From this point of view, the content of Co is preferably 0.10 at % or more, more preferably 1.00 at % or more, still more preferably 3.00 at % or more. On the other hand, since Co is expensive and Fe is least expensive, in view of profitability, the content of Fe is preferably 80.00 at % or more, more preferably 90.00 at % or more, relative to the entire T, and the entirety of T may be Fe.

### (Main Phase, Grain Boundary Phase and Intermediate Phase)

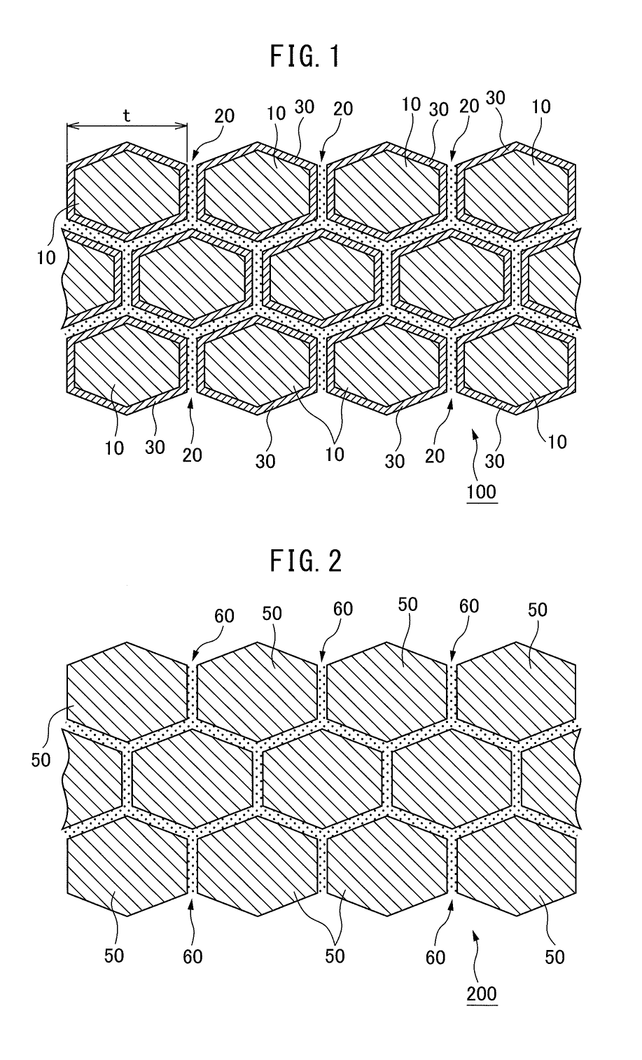

The structure of the rare earth magnet of the present disclosure having a total composition represented by the formula above is described below. FIG. 1 is a diagram schematically illustrating the structure of the rare earth magnet of the present disclosure. The rare earth magnet 100 has a main phase 10, a grain boundary phase 20, and an intermediate phase 30.

From the viewpoint of ensuring the coercive force, the average grain size of the main phase 10 is preferably 1,000 nm or less, more preferably 500 nm or less.

The “average grain size” indicates, for example, an average value of lengths t in the longitudinal direction of main phases 10 illustrated in FIG. 1. For example, a certain region is defined in a scanning electron micrograph or transmission electron micrograph of the rare earth magnet 100, and an average value of respective lengths t of the main phases 10 present within the certain region is calculated and taken as the “average grain size”. In the case where the cross-sectional shape of the main phase 10 is elliptic, the long axis is taken as the length t. In the case where the cross-section of the main phase 10 is quadrilateral in shape, the longer diagonal line is taken as the length t.

The rare earth magnet 100 may comprise a phase (not shown) other than the main phase 10, the grain boundary phase 20, and the intermediate phase 30. The phase other than the main phase 10, the grain boundary phase 20, and the intermediate phase 30 comprises an oxide, a nitride, an intermetallic compound, etc.

The properties of the rare earth magnet 100 are exerted mainly by the main phase 10, the grain boundary phase 20, and the intermediate phase 30. Most of the phases other than the main phase 10, the grain boundary phase 20, and the intermediate phase 30 are an impurity. Accordingly, the total content of the main phase 10, the grain boundary phase 20, and the intermediate phase 30 is preferably 95 vol % or more, more preferably 97 vol % or more, still more preferably 99 vol % or more, relative to the rare earth magnet 100.

The rare earth magnet precursor has a composition represented by the formula: CeₚR¹_{q}T_{(100-p-q-r-s)}BᵣM¹ₛ. FIG. 2 is a diagram schematically illustrating the structure of the rare earth magnet precursor. The rare earth magnet precursor 200 has a magnetic phase 50 and a (Ce,R¹)-rich phase 60. The magnetic phase 50 has a grain shape. The (Ce,R¹)-rich phase 60 is present around the magnetic phase 50. The (Ce,R¹)-rich phase 60 is formed by elements not contributing to the formation of the magnetic phase 50 and comprises high concentrations of Ce and R¹.

When the rare earth magnet precursor 200 is infiltrated with a modifier, the modifier reaches the interface between the (Ce,R¹)-rich phase 60 and the magnetic phase 50 through the (Ce,R¹)-rich phase 60. Then, a part of R² in the modifier infiltrates into the magnetic phase 50 from the (Ce,R¹)-rich phase 60, and Ce is discharged from the magnetic phase 50 to the (Ce,R¹)-rich phase 60. As a result, a main phase 10, a grain boundary phase 20, and an intermediate phase 30 are formed in a rare earth magnet 100.

The grain boundary phase 20 is present around the main phase 10. The intermediate phase 30 is sandwiched between the main phase 10 and the grain boundary phase 20. The concentration of Ce is higher in the main phase 10 than in the intermediate 30, and the concentration of R² is higher in the intermediate phase 30 than in the main phase 10.

Since Ce is a light rare earth element, when Ce in the magnetic phase is replaced by a rare earth element R² except for Ce, an anisotropic magnetic field can be increased. The concentration of R² is higher in the intermediate phase 30 than in the main phase 10, and the anisotropic magnetic field is therefore higher in the intermediate phase 30 (periphery of the magnetic phase) than in the main phase 10 (central part of the magnetic phase). Consequently, main phases 10 as the magnetic phase are magnetically separated from each other in a stronger manner by the intermediate phase 30 as well as the grain boundary phase 20, and the coercive force is thereby enhanced. The anisotropic magnetic field is a physical property indicating the magnitude of the coercive force of a permanent magnet.

When R² is one or more elements selected from Nd, Pr, Dy and Tb, the coercive force is more enhanced, because Nd, Pr, Dy and Tb can more increase the anisotropic magnetic field than other rare earth elements.

If the intermediate phase 30 is excessively thin, the magnetic separation effect can be hardly obtained, and the coercive force decreases. From this point of view, the thickness of the intermediate phase 30 is preferably 5 nm or more, more preferably 10 nm or more, still more preferably 20 nm or more. On the other hand, if the intermediate phase 30 is excessively thick, the magnetization is reduced. From this point of view, the thickness of the intermediate phase 30 is preferably 50 nm or less, more preferably 40 nm or less, still more preferably 30 nm or less.

When the concentration of R² is 1.5 times or more higher in the main phase 10 (central part of the magnetic phase) than in the intermediate phase 30 (periphery of the magnetic phase), the magnetic separation can be more distinctly recognized. On the other hand, when the concentration of R² is 10.0 times higher in the intermediate phase 30 (periphery of the magnetic phase) than in the main phase 10 (central part of the magnetic phase), the magnetic separation effect is not saturated. Accordingly, the concentration of R² is preferably from 1.5 to 10.0 times higher, more preferably from 1.50 to 5.0 times higher, still more preferably from 1.5 to 3.0 times higher, in the grain boundary phase 20 than in the main phase 10.

After the intermediate phase is formed, in order to allow a larger amount of R² to infiltrate into the intermediate phase 30, a larger amount of Ce is preferably discharged from the intermediate phase 30 to the gain boundary phase 20. It takes a time for R² to reach the main phase 10, and therefore, when a larger amount of Ce is discharged from the intermediate phase 30 to the grain boundary phase 20, the concentration of Ce becomes further higher in the main phase 10 than in the intermediate phase 30. When the concentration of Ce is 1.5 times or more higher in the main phase 10 than in the intermediate phase 30, infiltration of a larger amount of R² is recognized. On the other hand, when the concentration of Ce is 10.0 time higher in the main phase 10 than in the intermediate phase 30, the permeation of R² is not saturated. Accordingly, the concentration of Ce is preferably from 1.5 to 10.0 times higher, more preferably from 1.5 to 5.0 times higher, still more preferably from 1.5 to 3.0 times higher, in the main phase 10 than in the intermediate phase 30.

As seen from these, in the rare earth magnet 100 of the present disclosure, the coercive force of the rare earth magnet 100 can be more enhanced by infiltrating the rare earth magnet precursor 200 with a modifier.

### (Volume Fraction of Main Phase)

An R—Fe—B-based rare earth magnet is used as an anisotropic magnet in many cases. The same holds for the (Ce,R¹)—Fe—B-based rare earth magnet.

When anisotropy is imparted to the rare earth magnet 100, until up to a volume fraction of the main phase 10 of 96.20%, as the content of the main phase 10 increases, the magnetization increases. In order for the rare earth magnet 100 to have practical magnetization, the volume fraction of the main phase 10 is preferably 85.00% or more. From this point of view, the volume fraction of the main phase 10 is more preferably 92.30% or more, still more preferably 92.60% or more.

However, if the volume fraction of the main phase 10 exceeds 96.20%, the magnetization drastically decreases.

In order to impart anisotropy to the (Ce,R¹)—Fe—B-based rare earth magnet, for example, the entire rare earth magnet precursor 200 is subjected to severe hot working. In the grain boundary phase 20, the concentration of Ce is high, and therefore the melting point thereof is low. As a result, the grain boundary phase 20 slightly melts during sever hot working.

On the other hand, the main phase 10 rotates in easy axis direction of magnetization (c axis direction) while grains of the magnetic phase 50 being grown. At this time, the slightly melted grain boundary phase 20 acts like a lubricant for lubricating the rotation of the main phase 10. If the volume fraction of the main phase 10 exceeds 96.20%, the volume fraction of the (Ce,R¹)-rich phase acting like a lubricant is reduced, and this makes it difficult for the main phase 10 to rotate. As a result, the main phase 10 is not oriented in easy axis direction of magnetization (c axis direction), and magnetization drastically decreases. For these reasons, the volume fraction of the main phase 10 is preferably 96.20% or less, more preferably 96.10% or less.

The volume fraction of the main phase 10 is determined as follows. The content of each of Ce, Fe and B in the rare earth magnet 100 is measured using a high-frequency inductively coupled plasma emission spectrometry. These contents are converted from the value of mass percentage to the value of atomic percentage, and the obtained values are substituted into the equation based on a ternary Ce—Fe—B phase diagram in atomic percentages to calculate the volume fraction of the main phase 10. The volume fraction of the main phase 10 is a volume percentage assuming the entire rare earth magnet 100 is 100 vol %.

### (Production Method)

The production method of a rare earth magnet of the present disclosure is described below.

### (Preparation of Rare Earth Magnet Precursor)

An alloy comprising a total composition represented by the formula CeₚR¹_{q}T_{(100-p-q-r-s)}BᵣM¹ₛ is prepared. R¹, T, M¹, p, q, r, and s are as described above.

The rare earth magnet precursor 200 may be a magnetic powder or a sintered body of the magnetic powder or may also be a plastic formed body obtained by applying severe hot working to the sintered body.

As to the production method of the magnetic powder, a known method can be employed. The method includes, for example, a method of obtaining an isotropic magnetic powder having a nanocrystalline structure by a liquid quenching method, or a method of obtaining an isotropic or anisotropic magnetic powder by an HDDR (Hydrogen Disproportionation Desorption Recombination) method.

The method of obtaining a magnetic powder having a nanocrystalline structure by a liquid quenching method is roughly described. An alloy comprising the same composition as the total composition of the rare earth magnet precursor 200 is melted by high-frequency melting to prepare a molten alloy. For example, the molten alloy is ejected on a copper-made single roll in an Ar gas atmosphere under reduced pressure of 50 kPa or less to prepare a quenched ribbon. This quenched ribbon is pulverized, for example, to 10 μm or less.

The conditions in liquid quenching when using a copper-made single roll may be appropriately determined such that the obtained ribbon has a nanocrystalline structure.

The molten alloy ejection temperature may be typically 1,300° C. or more, 1,350° C. or more, or 1,400° C. or more, and may be 1,600° C. or less, 1,550° C. or less, or 1,500° C. or less.

The peripheral velocity of the single roll may be typically 20 m/s or more, 24 m/s or more, or 28 m/s or more, and may be 40 m/s or less, 36 m/s or less, or 32 m/s or less.

Next, the method for obtaining the sintered body is roughly described. The magnetic powder obtained by pulverization is subjected to magnetic field orientation, and a sintered boy having anisotropy is obtained via liquid phase sintering. Alternatively, a sintered body having isotropy is obtained by sintering a magnetic powder having an isotropic nanocrystalline structure; a plastic formed body having anisotropy is obtained by sintering a magnetic power having an isotropic nanocrystalline structure and further subjecting the sintered body to severe working; or a sintered body having isotropy or anisotropy is obtained by sintering a magnetic powder having isotropy or anisotropy obtained by an HDDR method.

In the case of obtaining a plastic formed body having anisotropy by sintering a magnetic power having an isotropic nanocrystalline structure and further subjecting the sintered body to severe working, the conditions in each step may be appropriately determined so that a desired plastic formed body can be obtained.

The pressure at the time of sintering may be 200 MPa or more, 300 MPa or more, or 350 MPa or more, and may be 600 MPa or less, 500 MPa or less, or 450 MPa or less.

The sintering temperature may be 550° C. or more, 600° C. or more, or 630° C. or more, and may be 750° C. or less, 700° C. or less, or 670° C. or less.

The pressurization time during sintering may be 2 seconds or more, 3 seconds or more, or 4 seconds or more, and may be 8 seconds or less, 7 seconds or less, or 6 seconds or less.

The temperature at the time of severe working of the sintered body may be 650° C. or more, 700° C. or more, or 720° C. or more, and may be 850° C. or less, 800° C. or less, or 770° C. or less.

The strain rate at the time of severe working of the sintered body may be 0.01/s or more, 0.1/s or more, 1.0/s or more, or 3.0/s or more, and may be 15.0/s or less, 10.0/s or less, or 5.0/s or less.

The method for severe working of the sintered body includes upsetting, backward extrusion, etc.

### (Preparation of Modifier)

A modifier comprising an alloy having a composition represented by R²₁₋ₓM²ₓ is prepared. R² is a rare earth element except for Ce. M² is an alloy element that makes, by alloying with R², the melting point of R²₁₋ₓM²ₓ to be lower than the melting point of R², and an unavoidable impurity. The proportions of R² and M² are 0.1≤x≤0.5.

The magnetic phase 50 of the rare earth magnet precursor 200 mainly contains Ce, whereas R² is a rare earth element except for Ce. Accordingly, the magnetic phase 50 of the rare earth magnet precursor 200 is easy to be infiltrated with R² in a melt of the modifier. As a result, a main phase 10 and an intermediate phase 30 comprising R² are obtained.

When R² is one or more elements selected from Nd, Pr, Dy and Tb, the coercive force is more enhanced, because Nd, Pr, Dy and Tb can more increase the anisotropic magnetic field than other rare earth elements. For this reason, R² is preferably one or more elements selected from Nd, Pr, Dy and Tb.

M² is an alloy element that makes, by alloying with R², the melting point of R²₁₋ₓM²ₓ to be lower than the melting point of R², and an unavoidable impurity, so that an alloy in the modifier can be melted without excessively raising the temperature of the later-described heat treatment. As a result, the modifier can infiltrate into the rare earth magnet precursor 200 without coarsening the structure of the rare earth magnet precursor 200. M² may contain an unavoidable impurity. The unavoidable impurity indicates an impurity that is unavoidably contained or causes a significant rise in the production cost for avoiding its inclusion, such as impurity contained in a raw material.

M² is preferably one or more elements selected from Cu, Al, and Co, and an unavoidable impurity, because Cu, Al, and Co have little adverse effect on the magnetic properties, etc. of the rare earth magnet.

The alloy of R² and M² includes an Nd—Cu alloy, a Pr—Cu alloy, a Tb—Cu alloy, a Dy—Cu alloy, an La—Cu alloy, a Ce—Cu alloy, an Nd—Pr—Cu alloy, an Nd—Al alloy, a Pr—Al alloy, an Nd—Pr—Al alloy, an Nd—Co alloy, an Pr—Co alloy, an Nd—Pr—Co alloy, etc.

The proportions of R² and M² are described. When x is 0.10 or more, the melting point of an alloy in the modifier properly lowers, and the temperature of the later-described heat treatment becomes reasonable. Consequently, the structure of the rare earth magnet precursor 200 can be prevented from coarsening. In view of a proper melting point of the alloy, x is preferably 0.20 or more, more preferably 0.25 or more. On the other hand, when x is 0.50 or less, since the content of R² in the alloy is large, R² can be easily made to infiltrate into the main phase 10 and the intermediate phase 30. From this point of view, x is preferably 0.40 or less, more preferably 0.35 or less. In the case where R² is two or more elements, 1-x is the proportion of the total thereof. In the case where M² is two or more elements, x is the proportion of the total of the elements.

The method for producing the modifier is not particularly limited. The production method of the modifier includes a casting method, a liquid quenching method, etc. From the viewpoint that the alloy component is small in variation depending on the region of the modifier or the amount of an impurity such as oxide is small, a liquid quenching method is preferred.

### (Preparation of Contact Body)

The rare earth magnet precursor 200 and the modifier are brought into contact with each other to obtain a contact body. In the case where both the rare earth magnet precursor 200 and the modifier are a bulk body, at least one surface of the rare earth magnet precursor 200 and at least one surface of the modifier are put into contact with each other. The bulk body includes a massive body, a plate material, a ribbon, a green compact, a sintered body, etc. For example, in the case where both the rare earth magnet precursor 200 and the modifier are a ribbon, one surface of the rare earth magnet precursor 200 and one surface of the modifier may be put into contact with each other, or the modifier may be put into contact with both surfaces of the rare earth magnet precursor 200 by sandwiching the rare earth magnet precursor 200 between modifiers.

In the case where the rare earth magnet precursor 200 is a bulk body and the modifier is a powder, the modifier powder may be put into contact with at least one surface of the rare earth magnet precursor 200. Typically, the modifier powder may be placed on top surface of the rare earth magnet precursor 200.

In the case where both the rare earth magnet precursor 200 and the modifier are a powder, respective powders may be mixed with each other.

### (Heat Treatment)

The above-described contact body is heat-treated to infiltrate the inside of the rare earth magnet precursor 200 with a melt of the modifier. Consequently, the melt of the modifier reaches the magnetic phase 50 of the rare earth magnet precursor 200 via the (Ce,R¹)-rich phase 60 of the rare earth magnet precursor 200 to form a main phase 10 and an intermediate phase 30 of the rare earth magnet 100.

The amount of the modifier infiltrated is preferably from 1.00 to 11.00 at % relative to the rare earth magnet precursor 200. When the modifier infiltrates even slightly into the inside of the rare earth magnet precursor 200, the rare earth magnet 100 of the present disclosure is obtained. When the amount of the modifier infiltrated is 1.00 at % or more, the effects of the rare earth magnet 100 of the present disclosure can be clearly recognized. From this point of view, the amount of the modifier infiltrated is preferably 2.60 at % or more, more preferably 4.00 at % or more, still more preferably 5.00 at % or more. On the other hand, when the amount of the modifier infiltrated is 11.00 at % or less, the effect due to permeation with the modifier is not saturated. From this point of view, the amount of the modifier infiltrated is preferably 7.90 at % or less, more preferably 7.00 at % or less.

The heat treatment temperature is not particularly limited as long as the modifier can melt and the inside of the magnetic phase 50 of the rare earth magnet precursor 200 can be infiltrated with a melt of the modifier.

As the heat treatment temperature is higher, the inside of the magnetic phase 50 of the rare earth magnet precursor 200 is more easily infiltrated with a melt of the modifier, particularly, with R². From this point of view, the heat treatment temperature is preferably 600° C. or more, more preferably 625° C. or more, still more preferably 675° C. or more. On the other hand, as the heat treatment temperature is lower, it is more facilitated to prevent coarsening of the structure, particularly the magnetic phase 50, of the rare earth magnet precursor 200. From this point of view, the heat treatment temperature is preferably 800° C. or less, more preferably 775° C. or less, still more preferably 725° C. or less.

The heat treatment atmosphere is not particularly limited, but from the viewpoint of preventing oxidation of the rare earth magnet precursor 200 and the modifier, an inert gas atmosphere is preferred. The inert gas atmosphere includes a nitrogen gas atmosphere.

### Examples

The rare earth magnet of the present disclosure and the production method thereof are described more specifically below by referring to Examples. The rare earth magnet of the present disclosure and the production method thereof are not limited to the conditions employed in the following Examples.

### (Preparation of Sample)

An alloy comprising the same composition as that of the rare earth magnet precursor shown in Table 1 was prepared. A melt of the alloy was subjected to liquid quenching by a single roll method to obtain a ribbon. The conditions in liquid quenching were a molten alloy temperature (ejection temperature) of 1,450° C. and a roll peripheral velocity of 30 m/s. The liquid quenching was performed in a reduced-pressure argon gas atmosphere. It was confirmed by scanning transmission electron microscope (STEM) observation that the ribbon has a nanocrystalline structure.

The ribbon was coarsely ground to prepare a powder, and the powder was charged into a die and pressurized/heated to obtain a sintered body. The pressurizing and heating conditions were an applied pressure of 400 MPa, a heating temperature of 650° C., and a pressurization and heating holding time of 5 seconds.

The sintered body was hot upset (severe hot working) to obtain a rare earth magnet precursor 200 (plastic formed body). The hot upsetting conditions were a working temperature of 750° C. and a strain rate of 0.1/s. It was confirmed by a scanning electron microscope (SEM) that the plastic formed body has an oriented nanocrystalline structure.

An Nd₇₀Cu₃₀ alloy was prepared as a modifier. An Nd powder and a Cu powder, produced by Kojundo Chemical Laboratory Co., Ltd., were weighed, and these powders were subjected to arc melting and liquid quenching to obtain a ribbon.

The rare earth magnet precursor 200 (plastic formed body) and the modifier (ribbon) were put into contact with each other and heat-treated in a heating furnace. The amount of the modifier was 5.3 at % (10 mass %) relative to the rare earth magnet precursor 200. A lamp furnace manufactured by ULVAC-RIKO, Inc. was used as the heating furnace. The heat treatment conditions were a heat treatment temperature of 700° C. and a heat treatment time of 360 minutes.

### (Evaluations)

Each sample was measured for the coercive force and the magnetization. The measurement was performed at normal temperature by using a Vibrating Sample Magnetometer (VSM) manufactured by Lake Shore.

With respect to some samples, a component analysis (EDX analysis) was performed by observing the structure by means of a scanning transmission electron microscope (STEM).

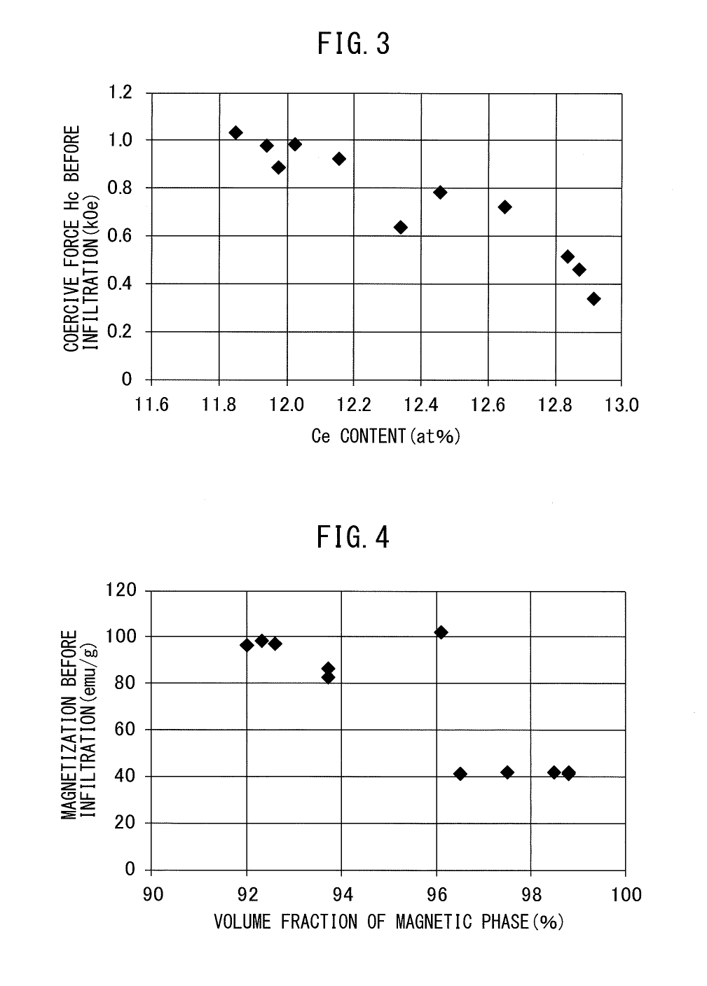

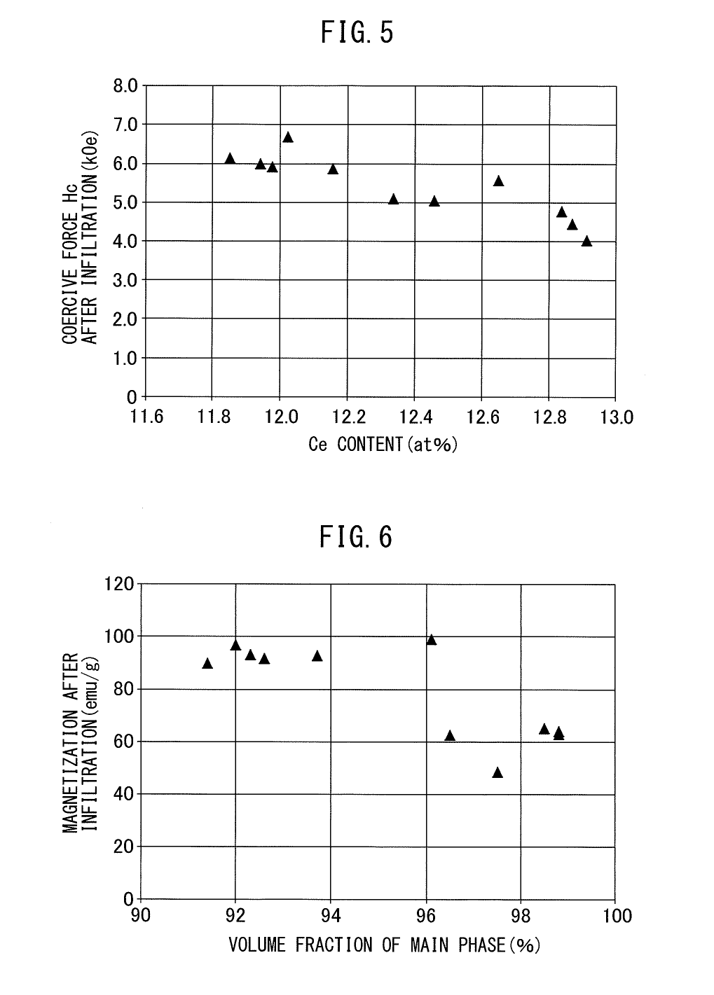

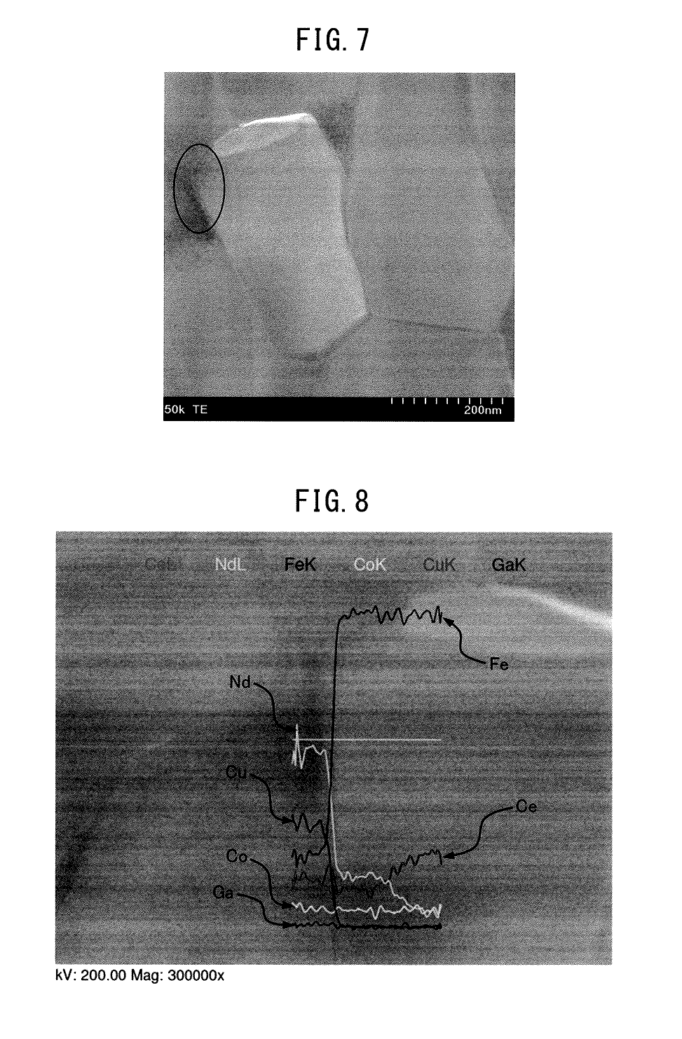

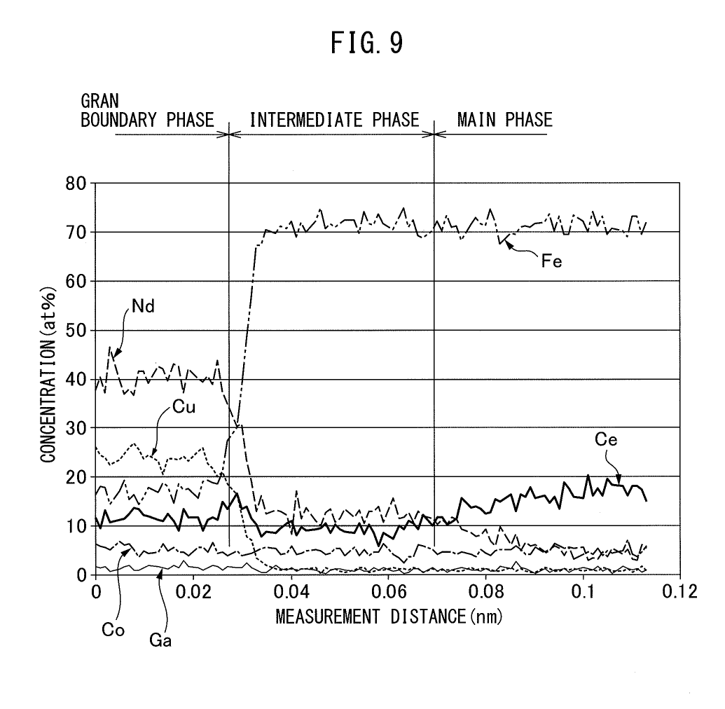

The evaluation results are shown in Table 1 and FIGS. 3 to 9. FIG. 3 is a graph illustrating the relationship between the Ce content and the coercive force before infiltration with the modifier in each sample. FIG. 4 is a graph illustrating the relationship between the volume fraction of magnetic phase 50 and the magnetization before infiltration with the modifier in each sample. FIG. 5 is a graph illustrating the relationship between the Ce content and the coercive force after infiltration with the modifier in each sample. FIG. 6 is a graph illustrating the relationship between the volume fraction of main phase 10 and the magnetization after infiltration with the modifier in each sample. FIG. 7 is a view showing a scanning transmission electron microscope image of the sample of Example 1. FIG. 8 is a diagram illustrating the results of component analysis (EDX analysis) of a portion surrounded by a black line in FIG. 7. In FIG. 8, the white straight line indicates the portion where EDX analysis was performed. FIG. 9 is a diagram summarizing the results of FIG. 8. In the column showing the content (at %) of Nd in Table 1, “-” indicates that the content is not more than the measurement limit. The measurement limit of Nd is 0.01 at % or less. The content of Ce in FIG. 3 is the value of p (at %) in CeₚR¹_{q}T_{(100-p-q-r-s)}BᵣM¹ₛ. The content of Ce in FIG. 5 is the value of p (at %) in CeₚR¹_{q}T_{(100-p-q-r-s)}BᵣM¹ₛ.

TABLE 1

| | | | | | | | | | | | Rare | | | |
|---|---|---|---|---|---|---|---|---|---|---|---|---|---|---|
| | | | | | | | | | | | Earth | | Rare | |
| | | | | | | | | | | Volume | Magnet | | Earth | |
| | | | | | | | | | | Fraction | Precursor | | Magnet | |
| | Total Composition of | | | | | | | | | of | (before | | (after | |
| | Rare Earth Magnet (at %) | | | | | | | | | Main | permeation) | | permeation) | |
| | | | | | | | | Alloy in | | Phase | Coer- | Magneti- | Coer- | Magneti- |
| | Rare Earth Magnet Precursor | | | | | | | Modifier | | (magnetic | cive | zation | cive | zation |
| | CeₚNd_{q}Fe_{(100-p-q-r-s )}BᵣM¹ₛ | | | | | | | (Nd_{0.7}Cu_{0.3})t | | phase) | Force Hc | Br | Force Hc | Br |
| | Ce | Nd | Fe | B | Ga | Cu | Al | Nd | Cu | (%) | (kOe) | (eum/g) | (kOe) | (eum/g) |
| Example 1 | 12.46 | — | 81.17 | 5.72 | 0.40 | 0.10 | 0.14 | 3.72 | 1.59 | 96.10 | 0.78 | 102.10 | 5.05 | 98.90 |
| Example 2 | 12.87 | — | 80.73 | 5.70 | 0.39 | 0.10 | 0.21 | 3.74 | 1.60 | 93.70 | 0.46 | 82.40 | 4.44 | 92.87 |
| Example 3 | 13.28 | — | 80.35 | 5.61 | 0.40 | 0.10 | 0.26 | 3.76 | 1.61 | 91.40 | — | — | 4.87 | 89.69 |
| Example 4 | 12.84 | — | 80.21 | 6.20 | 0.40 | 0.11 | 0.24 | 3.73 | 1.60 | 92.60 | 0.52 | 97.20 | 4.77 | 91.65 |
| Example 5 | 12.65 | — | 79.87 | 6.81 | 0.39 | 0.11 | 0.16 | 3.70 | 1.59 | 92.30 | 0.72 | 98.30 | 5.56 | 93.30 |
| Example 6 | 12.34 | — | 81.21 | 5.54 | 0.41 | 0.12 | 0.38 | 3.72 | 1.59 | 93.70 | 0.64 | 86.50 | 5.08 | 92.82 |
| Example 7 | 12.15 | — | 81.33 | 5.93 | 0.37 | 0.10 | 0.12 | 3.70 | 1.59 | 97.50 | 0.92 | 41.60 | 5.86 | 48.60 |
| Example 8 | 11.98 | — | 81.54 | 5.86 | 0.37 | 0.11 | 0.14 | 3.69 | 1.58 | 98.80 | 0.89 | 41.50 | 5.90 | 63.80 |
| Example 9 | 11.94 | — | 81.51 | 5.91 | 0.39 | 0.13 | 0.12 | 3.69 | 1.58 | 98.80 | 0.98 | 41.70 | 5.98 | 62.80 |
| Example 10 | 11.85 | — | 81.29 | 6.30 | 0.37 | 0.10 | 0.09 | 3.68 | 1.58 | 98.50 | 1.03 | 41.60 | 6.15 | 65.00 |
| Example 11 | 12.02 | — | 81.66 | 5.69 | 0.40 | 0.11 | 0.12 | 3.70 | 1.59 | 96.50 | 0.99 | 41.50 | 6.70 | 62.60 |
| Comparative | 12.91 | — | 80.94 | 5.47 | 0.38 | 0.11 | 0.19 | 3.75 | 1.59 | 92.00 | 0.34 | 96.70 | 4.02 | 96.64 |
| Example 1 | | | | | | | | | | | | | | |
| Comparative | 14.33 | — | 79.21 | 5.74 | 0.40 | 0.11 | 0.19 | 3.81 | 1.59 | 84.80 | — | — | 3.71 | 84.20 |
| Example 2 | | | | | | | | | | | | | | |

As seen from Table 1 and FIG. 3, it was confirmed that in a rare earth magnet precursor 200 where the content of Ce is from 11.80 to 12.90 at %, a coercive force of 0.40 kOe or more is obtained. In addition, as seen from Table 1 and FIG. 4, it was confirmed that in a rare earth magnet precursor 200 where the volume fraction of the magnetic phase 50 is from 92.30 to 96.20%, a magnetization of 80.00 emu/g or more is obtained.

As seen from Table 1 and FIG. 5, it was confirmed that in a rare earth magnet 100 where the content of Ce is from 11.80 to 12.90 at %, a coercive force of 4.40 kOe or more is obtained. In addition, as seen from Table 1 and FIG. 6, it was confirmed that in a rare earth magnet 100 where the volume fraction of the main phase 10 is from 92.30 to 96.20%, a magnetization of 80.00 emu/g or more is obtained.

As seen from FIGS. 7 to 9, it was confirmed that the concentration of Ce is higher in the main phase 10 than in the intermediate phase 30 and the concentration of Nd(R²) is higher in the intermediate phase 30 than in the main phase 10.

The effects of the present invention could be confirmed from these results.

### DESCRIPTION OF NUMERICAL REFERENCES

10 Main phase
20 Grain boundary phase
30 Intermediate phase
50 Magnetic phase
60 (Ce,R¹)-rich phase
100 Rare earth magnet
200 Rare earth magnet precursor

What is claimed is:

1. A rare earth magnet comprising:
a main phase,
a grain boundary phase present around the main phase, and
an intermediate phase sandwiched between the main phase and the grain boundary phase, and
wherein a total composition of the rare earth magnet is represented by the formula: CeₚR¹_{q}T_{(100-p-q-r-s)}BᵣM¹ₛ.(R²₁₋ₓM²ₓ)ₜ (wherein R¹ and R² are a rare earth element except for Ce, T is one or more elements selected from Fe, Ni, and Co, M¹ is one or more elements selected from Ti, Ga, Zn, Si, Al, Nb, Zr, Mn, V, W, Ta, Ge, Cu, Cr, Hf, Mo, P, C, Mg, Hg, Ag, and Au, and an unavoidable impurity, M² is an alloy element that makes, by alloying with R², the melting point of R²₁,M²ₓ to be lower than the melting point of R², and an unavoidable impurity, and
p, q, r, s, t, and x are
11.80≤p≤12.90,
0≤q≤3.00,
5.00≤r≤20.00,
0≤s≤3.00,
1.00≤t≤11.00, and
0.10≤x≤0.50),
the concentration of Ce is higher in the main phase than in the intermediate phase, and
the concentration of R² is higher in the intermediate phase than in the main phase.

2. The rare earth magnet according to claim 1, wherein the p is 11.80≤p≤12.20.

3. The rare earth magnet according to claim 1, wherein the q is 0≤q≤2.00.

4. The rare earth magnet according to claim 1, wherein the q is 0≤q≤1.00.

5. The rare earth magnet according to claim 1, wherein the volume fraction of the main phase is from 85.00 to 96.20%.

6. The rare earth magnet according claim 1, wherein the R¹ is one or more elements selected from Nd, Pr, Dy, and Tb.

7. The rare earth magnet according to claim 1, wherein the R² is one or more elements selected from Nd, Pr, Dy, and Tb.

8. The rare earth magnet according to claim 1, wherein the concentration of Ce is from 1.5 to 10.0 times higher in the main phase than in the intermediate phase.

9. The rare earth magnet according to claim 1, wherein the concentration of R² is from 1.5 to 10.0 times higher in the intermediate phase than in the main phase.

10. The rare earth magnet according to claim 1, wherein the x is 0.20≤x≤0.40.

11. The rare earth magnet according to claim 1, wherein the thickness of the intermediate phase is from 5 to 50 nm.

12. The rare earth magnet according to claim 1, wherein the T is Fe.

13. A method for producing a rare earth magnet according to claim 1, comprising:
preparing a rare earth magnet precursor comprising
a total composition of the rare earth magnet represented by the formula: CeₚR¹_{q}T_{(100-p-q-r-s)}BᵣM¹ₛ (wherein R¹ is a rare earth element except for Ce, T is one or more elements selected from Fe, Ni, and Co, M¹ is one or more elements selected from Ti, Ga, Zn, Si, Al, Nb, Zr, Mn, V, W, Ta, Ge, Cu, Cr, Hf, Mo, P, C, Mg, Hg, Ag, and Au, and an unavoidable impurity, and
p, q, r, and s are
11.80≤p≤12.90,
0≤q≤3.00,
5.00≤r≤20.00, and
0≤s≤3.00), and
a magnetic phase and a (Ce,R¹)-rich phase present around the magnetic phase,
preparing a modifier comprising an alloy represented by R²₁₋ₓM²ₓ (wherein R² is a rare earth element except for Ce, M² is an alloy element that makes, by alloying with R², the melting point of R²₁₋ₓM²ₓ to be lower than the melting point of R², and an unavoidable impurity, and 0.10≤x≤0.50),
bringing the rare earth magnet precursor and the modifier into contact with each other to obtain a contact body, and
heat-treating the contact body to infiltrate the inside of the magnetic phase of the rare earth magnet precursor with a melt of the modifier.

14. The method according to claim 13, wherein the p is 11.80≤p≤12.20.

15. The method according to claim 13, wherein the q is 0≤q≤2.00.

16. The method according to claim 13, wherein the q is 0≤q≤1.00.

17. The method according to claim 13, wherein the R¹ is one or more elements selected from Nd, Pr, Dy, and Tb.

18. The method according to claim 13, wherein the R² is one or more elements selected from Nd, Pr, Dy, and Tb and M² is one or more elements selected from Cu, Al, and Co, and an unavoidable impurity.

19. The method according to claim 13, wherein the x is 0.20≤x≤0.40.

20. The method according to claim 13, wherein the amount of the modifier infiltrated is from 1.0 to 11.0 at % relative to the rare earth magnet precursor.

21. The method according to claim 13, wherein the temperature of the heat treatment is from 600 to 800° C.

22. The method according to claim 13, wherein the T is Fe.
